(19) United States
(12) Patent Application Publication
(10) Pub. No.: US 2006/0129716 A1
(43) Pub. Date: Jun. 15, 2006

(54) Data storage device and buffer control method thereof

(75) Inventors: Takahiro Saito, Kanagawa (JP); Takayuki Yamaguchi, Kanagawa (JP); Atsushi Kanamaru, Kanagawa (JP); Shuhji Yamada, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/285,909

(22) Filed: Nov. 23, 2005

(30) Foreign Application Priority Data
Dec. 15, 2004 (JP) 2004-362237

(51) Int. Cl. G06F 5/00

(52) U.S. Cl. 710/52

(57) ABSTRACT

Embodiments of the invention reduce the host's wait time by controlling buffer for a data storage device. In a hard disk drive (HDD) disclosed herein, after write data from a host is stored in a write buffer, the size of a continuous free space left forward from the end position of the stored write data is detected. If the size is smaller than a criterion size, that is, the size is not large enough to store the next command's write data, the write buffer is searched for a continuous free space not smaller than the criterion size. If a continuous free space not smaller than the criterion size is detected, the HDD sets a write pointer to the continuous free space. This makes it possible to receive the next write data from the host and therefore reduce the host's wait time.

### CROSS-REFERENCES TO RELATED APPLICATIONS

This application claims priority from Japanese Patent Application No. JP2004-362237, filed Dec. 15, 2004, the entire disclosure of which is incorporated herein by reference.

### BACKGROUND OF THE INVENTION

The present invention relates to a data storage device and, in particular, to buffer control for a data storage device.

Data storage devices using various types of media such as optical disks and magnetic tapes are known. Among them, hard disk drives (hereinafter referred to as HDDs) have become popular as storage devices for computers to such an extent that they are one type of the storage devices indispensable for today's computers. Further, not limited to computer systems, HDDs are expanding more and more in application because of its excellent characteristics. For example, HDDs are used for moving picture recording/reproducing devices, car navigation systems, and removable memories for use in digital cameras.

Each magnetic disk used in HDDs has a plurality of tracks formed concentrically and each track is divided into a plurality of sectors. Servo data and user data are stored in each of the sectors. Data can be written to and read from a desired address by a head element which accesses a desired sector in accordance with the servo data stored in the sector. In a data read operation, a signal read from the magnetic disk by the head element is subjected to predetermined signal processing such as waveform shaping or decoding in a signal processing circuit and is then sent to a host. Data transferred from the host is subjected to predetermined signal processing in the signal processing circuit and is then written to the magnetic disk.

Write cache is known as one of the techniques for improving the performance of the HDD. In a HDD employing this technique, a write command from the host is cached and the accompanying write data is stored in a write buffer. When storing the write data into the write buffer is completed, the HDD sends a command completion notification to the host. In parallel with communication with the host, the HDD reads out write data from the write buffer and writes it to the magnetic disk. As one of the methods for handling such a write buffer, the single ring buffer method is known.

According to the single ring buffer method, write data from the host are stored in a single ring buffer in time-series order. In a typical single ring buffer method, the oldest write data is firstly written to the disk. When the write buffer is filled to the last location, the pointer returns to the first location. In this situation, if the write data stored in the first location is not yet written to the magnetic disk, it is not possible to receive the next write data from the host since the write buffer cannot store new write data.

Meanwhile, techniques are known which streamline the internal operation of the HDD so that all write data can be written to the magnetic disk in the shortest time. By using such algorithms as RPO (Rotational Positioning Optimization), these techniques (as disclosed in Patent Document 1 (Japanese Patent Laid-Open No. 2003-122631)) optimize the order of write data to be written to the disk. In an example RPO algorithm, the next command to be executed is selected from the queued commands according to the access times required to access the respective target sectors of these commands. The access time required to access the target sector of a command is calculated by estimating the seek time required to access the target track on the magnetic disk and the subsequent disk latency spent until the target sector arrives and adding up the seek time and the latency. A queued command which requires the shortest access time is selected as the next command to be executed.

### BRIEF SUMMARY OF THE INVENTION

Independently of the order in which write data were received, RPO determines the order of the write data to be written on the disk. Thus, write data stored in a write buffer are not written on the disk in time series order. Actually, it is possible that the oldest write data will be written last on the magnetic disk. In the single ring buffer scheme, as mentioned above, write data cannot be stored in the location in which the oldest data is stored until the oldest write data is written on the magnetic disk. Therefore, it is not possible to receive the next write data from the host until the oldest write data is extracted from the write buffer and written on the magnetic disk. This means that the host may wait for a long time since the host cannot issue the next write command to the HDD.

With the above-mentioned background, it is a feature of the present invention to reduce the host's waiting time by improving the write buffer control in the data storage device.

According to a first aspect of the present invention, there is provided a data storage device where write data from a host is written on a recording medium, comprising: a write buffer wherein the top end is concatenated with the rear bottom end and write data from a host is temporally stored in an area starting at a position to which a pointer is set; and a controller which controls storing of data in the write buffer, wherein, after write data from the host is stored in the write buffer, the controller detects the size of a continuous free space left forward from the end position of the stored write data; if the continuous free space is smaller than a criterion size, the controller searches the write buffer for a continuous free space not smaller than the criterion size; and if a continuous free space not smaller than the criterion size is detected by the search, the controller sets the pointer to the continuous free space.

According to a second aspect of the present invention, if the continuous free space left forward from the end position of the stored write data is not smaller than the criterion size, the controller sets the pointer to the end position without performing the search. This intends to raise the processing efficiency.

According to a third aspect of the present invention, the controller sends to the host a command completion notification for the write data after a continuous free space not smaller than the criterion size is detected. This makes it possible to surely prevent write data from being overwritten.

According to a fourth aspect of the present invention, the controller sets the pointer to the start position of the continuous free space detected by the search.

According to a fifth aspect of the present invention, the controller sets the pointer to the largest continuous free space in the write buffer. This makes it possible to reserve a wide space.

According to a sixth aspect of the present invention, if any continuous free space not smaller than the criterion size is not detected by the search, the controller postpones sending to the host a completion notification for the write data until a continuous fee space not smaller than the criterion size is detected. This makes it possible to surely prevent write data from being overwritten.

According to a seventh aspect of the present invention, after data is read out from the write buffer for write on the recording medium, the controller immediately searches the write buffer for a continuous free space not smaller than the criterion size. This makes it possible to quickly detect a required free space.

According to an eighth aspect of the present invention, if any continuous free space not smaller than the criterion size is not detected by the search, the priority of write data preceded by a continuous free space which is left forward from the end position is raised by the controller in the order of write on the recording medium. This makes it possible to quickly detect a required continuous free space.

According to a ninth aspect of the present invention, the write buffer functions as a single continuous section and can store write data in a continuous free space which starts at an arbitrary address. This makes it possible to more efficiently use the write buffer.

According to a tenth aspect of the present invention, there is provided a buffer control method for a data storage device where write data from a host is written on a recording medium, comprising the steps of: storing write data from a host in a write buffer wherein the top end is concatenated with the rear bottom end and data is stored in an area starting at a position to which a pointer is set; after write data from the host is stored in the write buffer, detecting the size of a continuous free space left forward from the end position of the stored write data; if the continuous free space is smaller than a criterion size, searching the write buffer for a continuous free space not smaller than the criterion size, and if a continuous free space not smaller than the criterion size is detected by the search, moving the pointer to the continuous free space.

According to an eleventh aspect of the present invention, if the continuous free space left forward from the end position is not smaller than the criterion size, the pointer is set to the end position.

According to a twelfth aspect of the present invention, if the continuous free space is not detected by the search, sending a notification which permits the host to send the next write command is postponed.

According to a thirteenth aspect of the present invention, if the continuous free space is not detected by the search, the write buffer is searched for a continuous free space not smaller than the criterion size each time data is read out from the write buffer for write on the recording medium.

According to the present invention, it is possible to more efficiently use the write buffer in a data storage device and reduce the host's wait time.

### BRIEF DESCRIPTION OF THE DRAWINGS

FIG. 1 is a block diagram which schematically shows the general configuration of an HDD embodiment of the present invention.

FIG. 2 is schematically depicted to explain how the write buffer is controlled in the embodiment.

FIG. 3 is schematically depicted to explain how the write buffer is controlled in the embodiment.

FIG. 4 shows the logical configuration which concerns the write buffer control in the HDD embodiment.

FIG. 5 shows an example of a write cache table to control the write buffer in the HDD embodiment.

FIG. 6 is a flowchart showing the write buffer control sequence in the embodiment.

FIG. 7 is a flowchart showing the write buffer control sequence in the embodiment.

FIG. 8 is a graph showing a result of IOPS (Input Output Per Second) and Max Response Time measurement done to compare the HDD embodiment and another HDD where search for continuous free space is not performed.

### DETAILED DESCRIPTION OF THE INVENTION

The following will describe an embodiment of the present invention. To make the description clear, omission and simplification are made as appropriate in the following paragraphs and the accompanying drawings. Also note that same reference numerals are each used to designate identical elements that are common to the figures and repetitive description is avoided as appropriate in the interest of straightforwardness.

With reference to the drawings, the following will provide a detailed description of a specific embodiment of the present invention. The present embodiment is obtained by applying the present invention to a hard disk drive (HDD), an example of a data storage device. To facilitate understanding of the present invention, its general configuration is described at first.

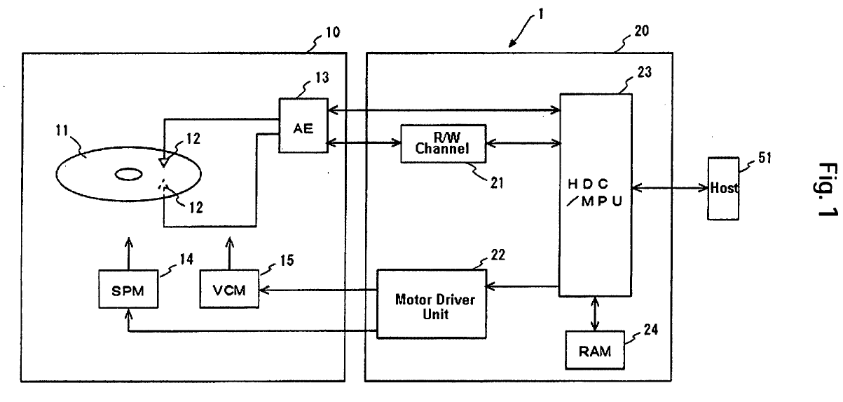

FIG. 1 is a block diagram which schematically shows the configuration of the present embodiment HDD 1. As shown in FIG. 1, the HDD 1 has a magnetic disk 11 which is an example of a recording medium, a head unit 12, arm electronics (AE) 13, a spindle motor (SPM) 14, and a voice coil motor (VCM) 15 in a sealed enclosure 10.

In addition, the HDD 1 has a circuit board 20 fixed to the outside of the enclosure 10. The circuit board 20 is provided with such ICs as a read/write channel (R/W channel) 21, a motor driver unit 22, a hard disk controller (HDC)/MPU integrated circuit (hereinafter referred to as HDC/MPU) 23, and a RAM 24 as an example of memory. Note that each circuit may be integrated either as a single IC or across a plurality of separate ICs.

Write data from an external host 51 is received by the HDC/MPU 23 and written onto the magnetic disk 11 by the head unit 12 via the R/W channel 21 and the AE 13. In addition, data stored on the magnetic disk 11 is read out by the head unit 12 and output to the external host 51 from the HDC/MPU 23 via the AE 13 and the R/W channel 21.

Now, individual components of the HDD 1 are described. The magnetic disk 11 is fixed to the SPM 14. The SPM 14 rotates the magnetic disk 11 at a certain speed. According to control data from the HDC/MPU 23, the motor driver unit 22 drives the SPM 14. The magnetic disk 11 in the present embodiment has a data recording surface on each side. Each recording surface is associated with a head unit 12.

Each head unit 12 is fixed to a slider (not shown in the figure). The slider is fixed to an actuator (not shown in the figure). The actuator is connected to the VCM 15. Swung by the VCM 15 about its pivot, the actuator moves the head unit 12 on the magnetic disk 11 in a radial direction. The motor driver unit 22 drives the VCM 15 according to control data from the HDC/MPU 23.

Typically, the head unit 12 has a write head and a read head which are formed integrally. By the write head, electric signal is converted to magnetic field according to the data to be recorded on the magnetic disk 11. By the read head, magnetic field from the magnetic disk 11 is converted to electric signal. Note that either one or plural magnetic disks 11 may be contained in the HDD 1. In addition, recording surface may be formed on either one or both sides of the magnetic disk 11.

Now, each circuit section is described below. For data access, the AE 13 chooses one head unit 12 from the plural head units 12. Signal read out by the selected head unit 12 is amplified (pre-amplified) in the AE 13 by a certain amount of gain. The pre-amplified read signal is sent to the R/W channel 21. In addition, write signal from the R/W channel 21 is sent by the AE 13 to a selected head unit 12.

The R/W channel 21 executes write processing on the data transferred from the host 51. In addition, when data is supplied to the host 51, the R/W channel 21 executes read processing. In the write processing, the R/W channel 21 code-modulates the write data supplied from the HDC/MPU 23 and further converts the code-modulated write data to a write signal (current) for supply to the AE 13. In the read processing, the R/W channel 21 amplifies the read signal supplied from the AE 13 to a certain level of amplitude, extracts data from the obtained read signal and decodes the data. The read data comprises user data and servo data. The decoded read data is supplied to the HDC/MPU 23.

The HDC/MPU 23 is a single chip circuit where a MPU and a HDC are integrated. The MPU operates according to microcodes loaded into the RAM 24. When the HDD 1 is started, not only microcodes which are to run on the MPU but also data required for control and data processing are loaded into the RAM 24 from the magnetic disk 11 or a ROM (not shown in the figure). In addition to head unit 12 positioning control, interface control, and operations required for data processing such as defect management, the HDC/MPU 23 executes general control of the HDD 1.

The read data from the magnetic disk 11, acquired from the R/W channel 21, is sent by the HDC/MPU 23 to the host 51. The data from the magnetic disk 11 is once stored in a read buffer in the RAM 24 before being transferred to the host 51 via the HDC/MPU 23. In addition, the write data from the host 51 is once stored in a write buffer in the RAM 24 via the HDC/MPU 23 before being transferred to the magnetic disk 11 at a certain timing via the HDC/MPU 23.

Now, the following describes how the write buffer is controlled in the present embodiment HDD 1. In the HDD 1, when the write cache is on, it is possible to send a write command completion notification to the host 51 upon completion of storing the corresponding write data in the write buffer. Upon receiving the command completion notification from the HDD 1, the host 51 becomes able to issue a new command to the HDD 1. By using an algorithm such as RPO (Rotational Positioning Optimization), the HDD 1 optimizes the order of write data to be recorded on the magnetic disk 11. Thus, the order of write data to be recorded on the magnetic disk 11 is set independently of the order in which the write data were received from the host 51 (the order in which they were stored in the write buffer).

The write buffer in the present embodiment is configured so that the first address is concatenated with the last address. If the write buffer is filled to the last address while write data is stored, the write buffer successively stores the remainder at the first and subsequent addresses. That is, write data associated with one write command can be stored across the last and first addresses in the write buffer. Concatenating the front end with the rear bottom end allows efficient use of the write buffer.

The addressing unit of the write buffer in the present embodiment is the sector which is a small data processing unit of the HDD 1. Write data associated with one write command is stored in a series of addresses. The write buffer of the present embodiment is not divided into a plurality of segments but configured as a single continuous section. Therefore, write data associated with one write command can be stored in a continuous free space which starts at an arbitrary address. Its configuration as a continuous section not as a plurality of segments makes it possible to more efficiently use the internal space of the buffer.

Storing of write data into the write buffer begins at an address (position) indicated by the write pointer. Likewise, reading out of write data for write to the magnetic disk 11 begins at an address (position) indicated by the read pointer. If conventional buffer control is made with a single ring buffer, the write buffer cannot store the next write data as mentioned above until the oldest write data is read out for write on the magnetic disk 11. In the case of the HDD 1 of the present embodiment, the write buffer is searched for a continuous free space which can be used to store the next write data.

More specifically, in the HDD 1 of the present embodiment, after write data from the host 51 is stored in the write buffer, the HDD 1 detects the size of the continuous free space which follows the last position of the area filled with the write data. If the size is smaller than the criterion size, that is, if the space is not large enough to store the next write command data, the write buffer is searched for a continuous free space whose size is not smaller than the criterion size. To optimize the order of write data to be written to the magnetic disk 11, as mentioned above, the order in which the HDD 1 of the present embodiment reads out data from the write buffer is different from the order in which the write data were stored in the write buffer. Thus, it is possible that one or more wide continuous free spaces exist which do not immediately follow the area filled with the last stored write data. If a continuous free space whose size is not smaller than the above-mentioned criterion size is found as a result of searching the write buffer, the HDD 1 sets the write pointer to that continuous space. This makes it possible to receive the next write data from the host 51, shortening the host's waiting time.

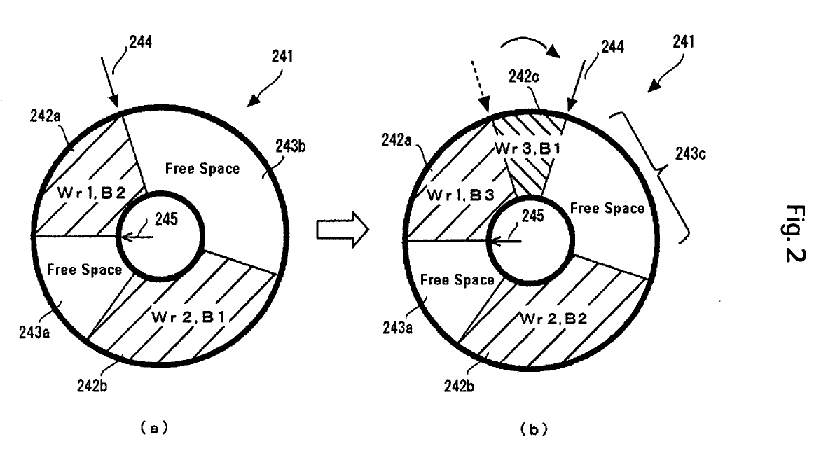

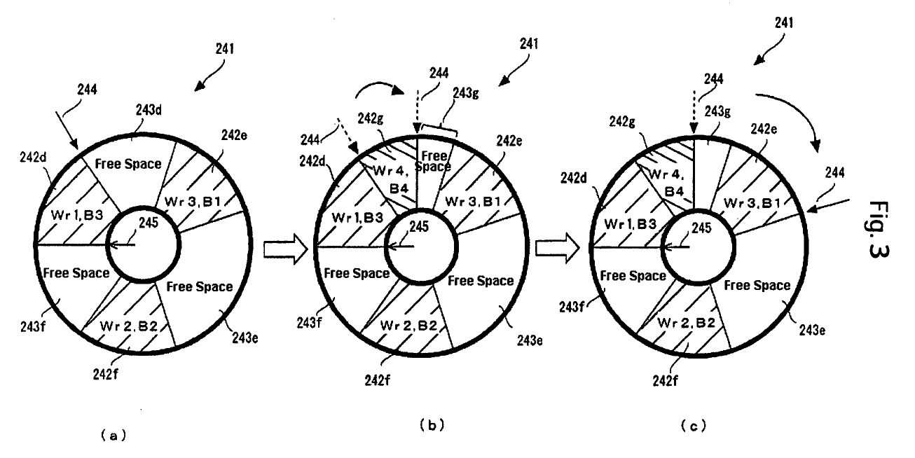

With reference to FIGS. 2 and 3, the following provides a concrete description of how the write buffer pointer is controlled in the present embodiment. FIGS. 2 and 3 schematically depict the write buffer of the present embodiment. In FIG. 2, after new write data is stored, a continuous free space whose size is not smaller than the criterion size is left forward from the end position of the newly stored write data. In the case of FIG. 3, after new write data is stored, no free space whose size is not smaller than the criterion size is left forward from the end position of the newly stored write data. Note that FIGS. 2 and 3 are schematic diagrams depicted to explain the buffer control in the present embodiment. Typically in the actual device, the write buffer is configured so as to have a capacity to store write data for several tens of write commands.

At first, the following describes FIG. 2 where after write data is stored, a continuous free space whose size is not smaller than the criterion size is left forward from the end position of the stored write data. In FIG. 2(a), the write buffer 241 has data storage areas 242a and 242b and continuous free areas 243a and 243b. Write data in data storage areas 242a and 242b are not yet written on the magnetic disk 11. In continuous free areas 243a and 243b, new write data can be stored. Write data stored in each of data storage areas 242a and 242b is associated with one write command. In FIG. 2, storing of write data advances clockwise in the write buffer 241.

In data storage areas 242a and 242b, Wrk (k: natural number) means that the write data is the kth data to be written on the magnetic disk 11. Wr1 in data storage area 242a is the first write data to be written on the magnetic disk 11. Bk (k: natural number) means its serial position number in the buffer. This position order is taken clockwise from a reference position (reference address). In this example, the reference position is set at the 12:00 position. The write pointer 244 is set to the start position (start address) of continuous free space 243b (the end position of data storage area 242a). The read pointer 245 is set to the start position of data storage area 242a labeled with Wr1.

If new write data is received from the host 51, storing of this write data starts at the position to which the write pointer 244 is set in the write buffer 241. As a result of storing the new write data in the write buffer 241, the write buffer 241 has data storage area 242c filled with the new write data as shown in FIG. 2(b). In this example of FIG. 2(b), continuous free space 243c whose size is not smaller than the criterion size is left forward from the end position of the newly stored write data (data storage area 242c). Therefore, the HDD 1 sets the write pointer to the start position of continuous free space 243c (the end position of the newly stored write data) without searching for another continuous free space.

In addition, while disk write priority rank Wrk and in-buffer serial position number Bk to the magnetic disk 11 are set to the newly stored write data, those set to the older write data are changed as necessary. In this example of FIG. 2(b), disk write priority rank Wr3 and in-buffer serial position number B1 are set to the newly stored write data. The disk write priority ranks set respectively to the write data in data storage areas 242a and 242b are not changed. However, the in-buffer serial position numbers set to them are changed to B3 and B2, respectively.

Now, the following describes FIG. 3 where after write data is stored, a continuous free space whose size is not smaller than the criterion size is not left forward from the end position of the stored write data. In FIG. 3(a), the write buffer 241 has data storage areas 242d, 242e and 242f and continuous free areas 243d, 243e and 243f. Write data stored in data storage areas 242d, 242e and 242f are not yet written on the magnetic disk 11. In continuous free areas 243d, 243e and 243f, new write data can be stored. To each stored write data, disk write priority rank Wk and in-buffer serial position number Bk are set according to the same rule as in FIG. 2. The write pointer 244 is set to the start position (start address) of continuous free space 243d (the end position of data storage area 242d). The read pointer 245 is set to the start position of data storage area 242d labeled with Wr1.

If new write data is received from the host 51, storing of this write data starts at the position to which the write pointer 244 is set in the write buffer 241. As a result of storing the new write data in the write buffer 241, the write buffer 241 has data storage area 242g filled with the new write data as shown in FIG. 3(b). Although continuous free space 243g is left forward from the end position of the newly stored write data (data storage area 242g), its size is smaller than the criterion size. Therefore, the HDD 1 searches the write buffer 241 for a continuous free space whose size is not smaller than the criterion size. In this example, since the size of continuous free space 243e is not smaller than the criterion size, the HDD 1 sets the write pointer 244 to the start position of continuous free space 243e. In addition, as described with reference to FIG. 2, setting disk write priority rank Wrk and in-buffer serial position number Bk to each write data is executed again.

As mentioned above, in the HDD 1 of the present invention, after new write data is stored in the write buffer, the size of the continuous free space left forward from the end position of the newly stored write data is detected. If the size of the continuous free space is smaller than the criterion size, the write buffer is searched for another continuous free space. If a continuous free space whose size is not smaller than the criterion size is found as the result of the search, the HDD 1 moves the write pointer to that free continuous space. For efficient free space utilization, it is preferable to set the write pointer to the start position of the continuous free space. In addition, if the data length of each write data is variable, it is preferable to set the write pointer to the widest (largest) continuous free space.

Thus, even if old write data are left in the write buffer, the next write data can be stored in a discrete free space in the write buffer. This allows the host 51 to issue the next write command, shortening the wait time of the host 51. If a continuous free space whose size is not smaller than the criterion size is left forward from the end position of the last stored write data, the HDD 1 sets the write pointer to the end position of the write data (the start position of the adjacent continuous free space) without searching for another continuous free space. This realizes quick buffer control without performing unnecessary processing.

If a continuous free space whose size is not smaller than the criterion size is not left forward from the end position of the last stored write data and searching the writ buffer 241 fails to find any continuous free space whose size is not smaller than the criterion size, the HDD 1 puts off sending the command completion notification to the host 51. Command completion notification means that a new command issue to the host 51 is permitted. The host 51 cannot issue a command until the command completion notification is received.

In order to shorten the wait time of the host 51, it is preferable to rearrange the magnetic disk 11 write priority ranks set to the write data stored in the write buffer if a required continuous free space is not left in the write buffer as mentioned above. The priority ranks determine the order of the write data to be written on the magnetic disk 11. Write data assigned a higher priority will be written earlier on the magnetic disk 11. Therefore, even if a higher priority is set, the order of the write data to be written may not be changed. It can be designed so as to prefer the order of the write data by always raising priority. In this case, if the first order of the disk write is set (Wr1 in FIG. 2), the wait time of the host 51 can greatly be reduced.

For example, it is preferable to raise the priority of the write data preceded by a continuous free space which is left forward from the end position of the newly stored write data. It is also preferable to raise the priority of the largest write data. Write data sandwiched between two discrete continuous free spaces may be given a higher priority, too. This makes it possible to provide a wide, continuous free space. Accordingly, the write data to be given the highest priority can be selected so as to create the largest free space after the selected write data is read out. In response to data write on the magnetic disk 11, the HDD 1 searches again for a continuous free space. Preferably, search is executed repeatedly each time write operation is done until a satisfactory continuous free space is found. This makes it possible to send a completion notification to the host 51 immediately after a satisfactory continuous free space is formed.

The above-mentioned criterion size may be either fixed or varied. For example, if the maximum data length of write data to be sent from the host 51 is fixed, this fixed maximum data length may be set as the criterion size. In this case, all write commands can be handled without overwriting existing data. If the HDD 1 implements such a feature as NCQ (Native Command Queuing) specified by the SATA (Serial ATA), the HDD 1 can control the order of write data to be sent from the host 51. In this case, it is possible to set the criterion size equal to the data length of next write data to be sent from the host 51 since the HDD 1 knows the data length of the next write data to be sent. The criterion value changes according to the next write data. This variable setting may reduce the wait time of the host 51 since it raises the possibility that the next write data can be received with small continuous free spaces.

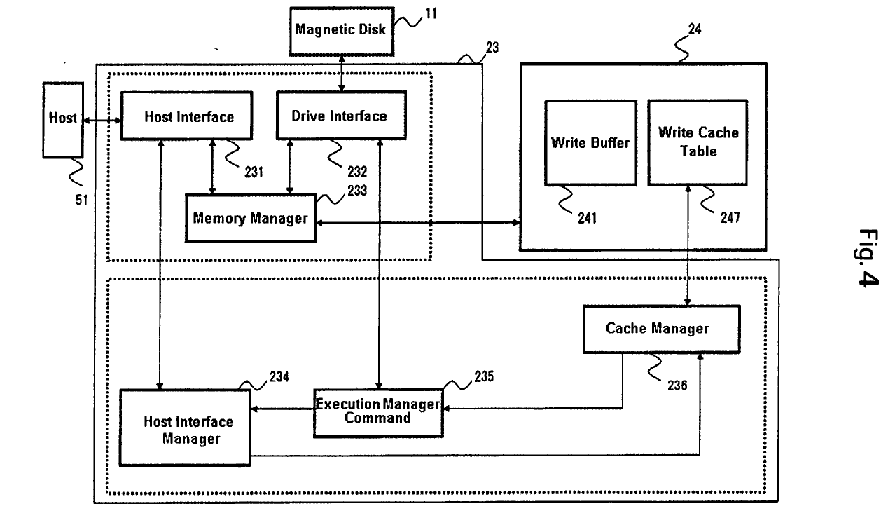

In the present embodiment, storing of data in the write buffer 241 is controlled by the HDC/MPU 23. The following provides a detailed description of how the write buffer 241 is controlled by the HDC/MPU 23. FIG. 4 is a block diagram of a configuration which concerns the control of the write buffer 241 in the HDD 1. The hardware configuration of the HDC/MPU 23 comprises a host interface 231, a drive interface 232, and a memory manager 233. Microcodes which run on the MPU enable the MPU to function as a host interface manager 234, a command execution manager 235, and a cache manager 236. Temporarily storing commands and data, a memory RAM 24 can function as a write buffer 241 and a write cache table 247.

Functioning as a data transmission unit, the host interface 231 executes actual data transmission with the host 51. The drive interface 232 performs actual data input and output with the magnetic disk 11 (or with the read write channel 21). The memory manager 233 controls storing of data in the RAM (memory) 24 and performs intermediary processing on commands and user data (write/read data) between the RAM 24 and other function blocks in the HDC/MPU 23.

Functioning as a data transmission control unit to control the host interface 231, the host interface manager 234 exchanges certain notifications and instructions with the host interface 231. The cache manager 236 not only sets the write pointer 244 and the read pointer 245 in the write buffer 241 according to the write cache table 247 to which it refers, but also reschedules the queued write commands so as to optimize the command execution order in terms of performance. The command execution manager 235 controls execution of commands according to the order determined by the cache manager 236. In addition, the command execution manager 235 controls data write to and data read from the magnetic disk 11 by controlling the drive interface 232.

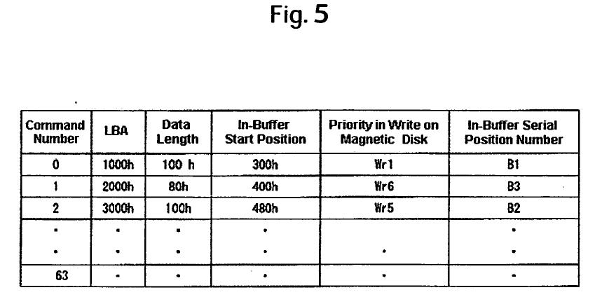

FIG. 5 shows an example of the write cache table 247. In FIG. 5, “Command Number” indicates each command's identifier in the write cache table 247. “Data Length” indicates the data length of the write data associated with each write command. “In-Buffer Start Position” indicates the start position of each write data in the write buffer. “Priority in Write on Magnetic Disk” indicates where each write data is in the order of the write data to be read out for write on the magnetic disk 11. In this example, the write data given Wr1 is the first write data to be written on the magnetic disk 11. “In-Buffer Serial Position Number” indicates where each data is in the write buffer 241 and is counted from a specific base address (for example, the top position of the write buffer).

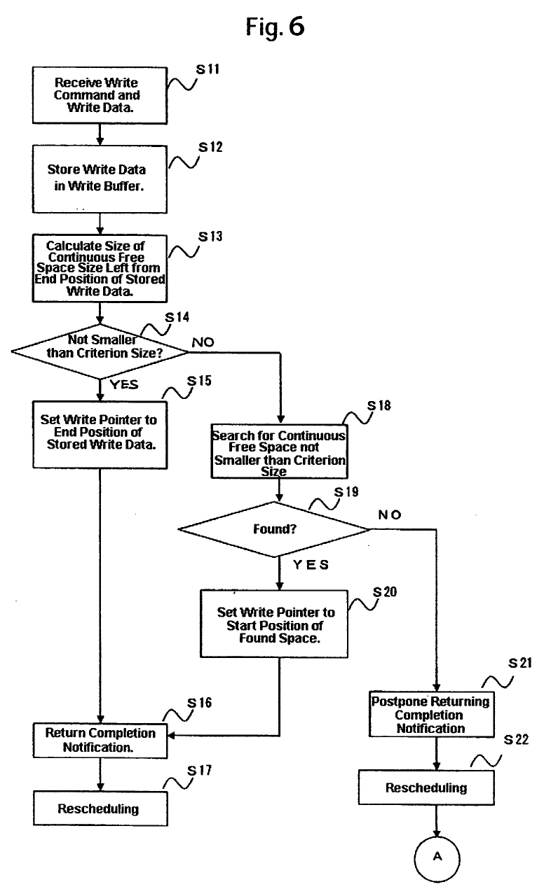

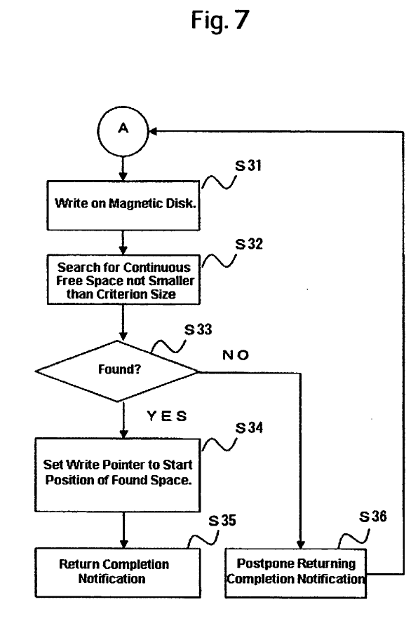

Now, the following describes the write buffer 241 control sequence with reference to the flowcharts of FIGS. 6 and 7. In FIG. 6, if a write command and write data are received from the host 51 by the host interface 231 in S11, the memory manager 233 stores the write data in the write buffer 241 (S12). The memory manager 233 is provided with a register (not shown in the figure) in which the write pointer 244 and the read pointer 245 are set. Write data is stored in a location to which the write pointer 244 points. Likewise, write data is read out according to the read pointer 245.

The cache manger 246 registers the write command in the write cache table 247. That is, the host interface 231 notifies the cache manager 236 of the reception of the write command, its LBA (Logical Block Address), and data length via the host interface manager 234. Upon reception of the write command, the cache manager 236 registers the data in an empty record entry of the write cache table 247. For example, the order of write data to be written on the magnetic disk may be set identical to their latest order in the write cache table 247.

The cache manger 236 refers to the write cache table 247 and calculates the size of a continuous free space which extends forward from the end position of the newly stored write data in the write buffer 241 (S13). From the start position and data length of the newly stored write data in the buffer and the start position of the subsequent write data in the buffer 241, the cache manager 236 can calculate the size of the continuous free space. The subsequent write data can be identified by referring to the in-buffer position numbers.

The cache manager 236 judges whether the calculated size of the continuous free space is not smaller than the criterion size. As mentioned earlier, the HDD 1 is designed so as to set an appropriate value to the criterion size. If the continuous free space is not smaller than the criterion size in S14, the cache manager 236 determines the end position of the newly stored write data (the start position of the subsequent adjacent free space) as the write pointer 244 and sets it in the register of the memory manager 233 (S15). Further, the cache manager 236 requests the host interface manager 234 to return a command completion notification 51 to the host 51. The host interface manager 234 returns a command completion notification to the host 51 via the host interface 231 (S16). Further, based on the LBA acquired from the host interface manager 234, the cache manager 236 reschedules the order of the write commands to be executed, that is, the order of the write data to be written on the magnetic disk 11 (S17).

If the continuous free space is smaller than the criterion size in S14, the cache manager 236 searches the write buffer 241 for a continuous free space not smaller than the criterion size (S18). The cache manager 236 can detect the presence and size of each free space by referring to the write cache table 247. If a continuous free space not smaller than the criterion size is detected in S19, the cache manger 236 determines to set the write pointer to the start (first) position of the free space and sets it in the register of the memory manager 233 (S20). After that, a command completion notification is returned to the host 51 in S16 and then the order of write commands to be executed is rescheduled (S17). If any continuous free space not smaller than the criterion size is not found in S19, the cache manager 236 determines to postpone returning a command completion notification to the host 51 (S21) and reschedules the order of the write data to be written on the magnetic disk 11 (S22).

After that, as shown in FIG. 7, the cache manager 236 notifies the command execution manager 235 which write command should be executed. The command execution manager 235 instructs the drive interface 232 to write the write command's write data on the magnetic disk 11. The drive interface 232 acquires the write data from the write buffer 241 via the memory manager 233 and sends the write data for write on the magnetic disk 11 (S31).

Upon reading out the write data from the write buffer 241 for write on the magnetic disk 11, the cache manager 236 searches the write buffer 241 for a continuous free space not smaller than the criterion size (S32). If a continuous free space not smaller than the criterion size is found in S33, the cache manager 236 determines to set the write pointer to the start position of the space and sets it in the register of the memory manager 233 (S34). After that, a command completion notification is returned to the host 51 as well (S35). If any continuous free space not smaller than the criterion size is not found in S33, the cache manager 236 determines to postpone returning a command completion notification and repeats the above-mentioned processing (S36).

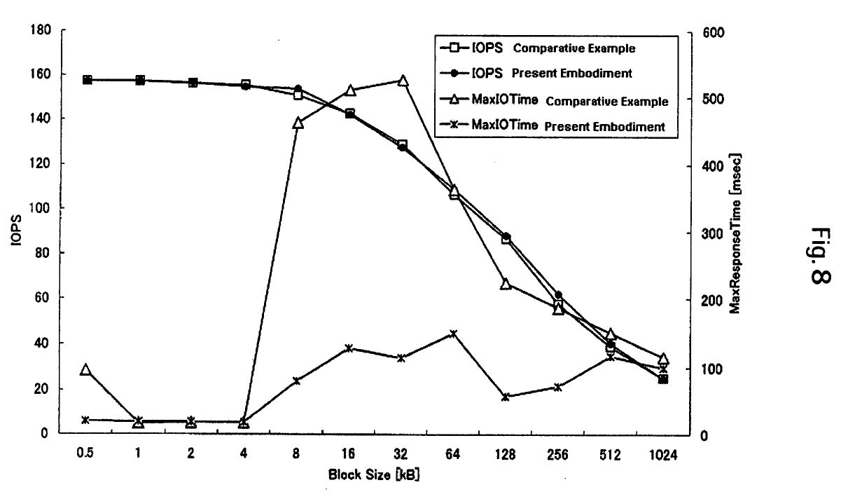

FIG. 8 shows a result of comparing the present HDD embodiment and another HDD in terms of IOPS (Input Output Per Second) and Max Response Time (maximum time until completion notification is sent to the host). While the write buffer is controlled as mentioned so far in the present HDD embodiment, search for continuous free space is not done in the HDD cited for comparison. In FIG. 7, the X axis represents the user data block size. The left and right Y axes respectively represent the IOPS and the Max Response Time. As understood from FIG. 7, the present HDD embodiment shows a great improvement in the Max Response Time without deterioration in the IOPS as compared with the other HDD.

While a specific embodiment of the present invention has been described above, it is to be understood that the present invention is not limited to the specific embodiment. Those skilled in the art may readily make alterations, additions and changes to each component of the embodiment without departing from the scope of the present invention. For example, the write buffer control in the embodiment may be applied to data storage devices using other recording media than magnetic disks.

What is claimed is:

1. A data storage device where write data from a host is written on a recording medium, comprising:
a write buffer wherein a top end is concatenated with a bottom end and write data from a host is temporally stored in an area starting at a position to which a pointer is set; and
a controller which controls storing of data in the write buffer;
wherein:
after write data from the host is stored in the write buffer, the controller detects the size of a continuous free space left forward from an end position of the stored write data;
if the continuous free space is smaller than a criterion size, the controller searches the write buffer for a continuous free space not smaller than the criterion size; and
if a continuous free space not smaller than the criterion size is detected by the search, the controller sets the pointer to the continuous free space.

2. A data storage device according to claim 1, wherein if the continuous free space left forward from the end position of the stored write data is not smaller than the criterion size, the controller sets the pointer to the end position without performing the search.

3. A data storage device according to claim 1, wherein after a continuous free space not smaller than the criterion size is detected, the controller sends to the host a command completion notification for the write data.

4. A data storage device according to claim 1, wherein the controller sets the pointer to a start position of the continuous free space detected by the search.

5. A data storage device according to claim 1, wherein the controller sets the pointer to a largest continuous free space in the write buffer.

6. A data storage device according to claim 1, wherein if any continuous free space not smaller than the criterion size is not detected by the search, the controller postpones sending to the host a completion notification for the write data until a continuous free space not smaller than the criterion size is detected.

7. A data storage device according to claim 1, wherein after data is read out from the write buffer for write on the recording medium, the controller immediately searches the write buffer for a continuous free space not smaller than the criterion size.

8. A data storage device according to claim 1, wherein if any continuous free space not smaller than the criterion size is not detected by the search, the priority of write data preceded by a continuous free space which is left forward from the end position is raised by the controller in the order of write on the recording medium.

9. A data storage device according to claim 1, wherein the write buffer functions as a single continuous section and can store write data in a continuous free space which starts at an arbitrary address.

10. A buffer control method for a data storage device where write data from a host is written on a recording medium, comprising:
storing write data from a host in a write buffer wherein the top end is concatenated with the rear bottom end and data is stored in an area starting at a position to which a pointer is set;
after write data from the host is stored in the write buffer, detecting the size of a continuous free space left forward from the end position of the stored write data;
if the continuous free space is smaller than a criterion size, searching the write buffer for a continuous free space not smaller than the criterion size, and if a continuous free space not smaller than the criterion size is detected by the search, moving the pointer to the continuous free space.

11. A buffer control method for a data storage device according to claim 10, wherein if the continuous free space left forward from the end position is not smaller than the criterion size, the pointer is set to the end position.

12. A buffer control method for a data storage device according to claim 10, wherein if the continuous free space is not detected by the search, sending a notification which permits the host to send the next write command is postponed.

13. A buffer control method for a data storage device according to claim 12, wherein if the continuous free space is not detected by the search, the write buffer is searched for a continuous free space not smaller than the criterion size each time data is read out from the write buffer for write on the recording medium.

14. A buffer control method according to claim 10, further comprising after a continuous free space not smaller than the criterion size is detected, sending to the host a command completion notification for the write data.

15. A buffer control method according to claim 10, further comprising setting the pointer to a start position of the continuous free space detected by the search.

16. A buffer control method according to claim 10, further comprising setting the pointer to a largest continuous free space in the write buffer.

17. A buffer control method according to claim 10, further comprising if any continuous free space not smaller than the criterion size is not detected by the search, raising the priority of write data preceded by a continuous free space which is left forward from the end position in the order of write on the recording medium.

18. A buffer control method according to claim 10, wherein the write buffer functions as a single continuous section and can store write data in a continuous free space which starts at an arbitrary address.
